(19) United States
(12) Patent Application Publication
(10) Pub. No.: US 2011/0207093 A1
(43) Pub. Date: Aug. 25, 2011

(54) HANDHELD BRAILLE CONVERTING DEVICE, BRAILLE CONVERTING METHOD, AND BRAILLE CONVERTING PROGRAM

(76) Inventor: Anthony Thomas Keyes, Kawagoe (JP)

(21) Appl. No.: 13/063,596

(22) PCT Filed: Sep. 10, 2009
(86) PCT No.: PCT/JP2009/065865

§ 371 Date: Mar. 31, 2011

(30) Foreign Application Priority Data
Sep. 12, 2008 (JP) 2008234752

(51) Int. Cl. G09B 21/00

(52) U.S. Cl. 434/114

(57) ABSTRACT

When a user positions a handheld Braille converting device on an object, a CCD camera captures an image of a predetermined range around it. The presence/absence of character(s) is detected based on the captured image. When the characters exist, the characters are recognized, and the recognized characters are converted to Braille and displayed. When the relative position between the moving direction of the handheld Braille converting device and the character string existing in the captured image is not correct, an error is displayed.

### TECHNICAL FIELD

The present invention relates to a method of converting characters to Braille.

### BACKGROUND TECHNIQUE

As a character reading device for a visually handicapped person, there is known a Braille display device which converts electronic data of a line of characters into Braille and displays it.

Patent Reference-1 discloses an electronic data display system which converts text data in a computer into Braille and displays it.

### RELATED ART DOCUMENT

### Patent Document

Patent Reference-1:
   Japanese Patent Application Laid-open under No. 2003-502699

However, there is such a problem in the above character recognition device that characters on a printed matter cannot be easily converted into Braille on the spot.

### DISCLOSURE OF INVENTION

### Problem to be Solved by the Invention

The above is an example of the problem to be solved by the present invention. An object of the present invention is to provide a Braille converting device easily carried by a user and capable of easily converting characters on a printed matter into Braille on the spot.

### Means for Solving the Problem

The invention according to claim 1 is a handheld Braille converting device movable while being held by a user by a single hand, comprising: a Braille display unit which is arranged at a position capable of being contacted by at least one finger of a hand of the user holding the device and which displays Braille; an image capturing means which captures a predetermined range around the device; a character recognition means which detects the presence/absence of character(s) existing in an image captured by the capturing means and recognizes the character (s); a Braille converting means which converts a part of or all the characters recognized by the character recognition means to Braille; and a display control means which displays the Braille converted by the Braille converting means on the Braille display unit.

The invention according to claim 13 is a Braille converting method executed by a handheld Braille converting device movable while being held by a user by a single hand and including a Braille display unit which is arranged at a position capable of being contacted by at least one finger of a hand of the user holding the device and which displays Braille, the method comprising: an image capturing process which captures a predetermined range around the device; a character recognition process which detects the presence/absence of character(s) existing in an image captured by the capturing process and recognizes the character(s); a Braille converting process which converts a part of or all the characters recognized by the character recognition process to Braille; and a display control process which displays the Braille converted by the Braille converting process on the Braille display unit.

The invention according to claim 14 is a Braille converting program executed by a handheld Braille converting device movable while being held by a user by a single hand and including a Braille display unit which is arranged at a position capable of being contacted by at least one finger of a hand of the user holding the device and which displays Braille, the program making the Braille converting device function as: an image capturing means which captures a predetermined range around the device; a character recognition means which detects the presence/absence of character(s) existing in an image captured by the capturing means and recognizes the character(s); a Braille converting means which converts a part of or all the characters recognized by the character recognition means to Braille; and a display control means which displays the Braille converted by the Braille converting means on the Braille display unit.

### BRIEF DESCRIPTION OF THE DRAWINGS

FIG. 1 is a block diagram showing a configuration of a handheld Braille converting device.

FIGS. 2A and 2B are block diagrams showing a structure of the handheld Braille converting device.

FIG. 3 is a block diagram showing a functional configuration of the handheld Braille converting device.

FIGS. 4A to 4D shows examples of Braille display units.

FIGS. 5A to 5G are examples of a Braille display and a relative position indication display.

FIG. 6 is a flowchart of a Braille converting process.

### DETAILED DESCRIPTION OF THE PREFERRED EMBODIMENTS

According to one aspect of the present invention, there is provided a handheld Braille converting device movable while being held by a user by a single hand, comprising: a Braille display unit which is arranged at a position capable of being contacted by at least one finger of a hand of the user holding the device and which displays Braille; an image capturing means which captures a predetermined range around the device; a character recognition means which detects the presence/absence of character(s) existing in an image captured by the capturing means and recognizes the character(s); a Braille converting means which converts a part of or all the characters recognized by the character recognition means to Braille; and a display control means which displays the Braille converted by the Braille converting means on the Braille display unit.

The above handheld Braille converting device completes the process from the reading of the characters to the output of the Braille by itself. Also, the device has a size capable of being held by a single hand. Thus, it is possible to provide a Braille converting device which is easily carried by a user and which can easily convert characters around the user to Braille on the spot.

In one mode, the handheld Braille converting device is movable on a surface of a printed matter. The image capturing means captures a predetermined range on the surface of the printed matter, and the character recognition means detects the presence/absence of the character(s) printed on the surface of the printed matter captured and recognizes the character(s). By this, the printed matter such as a newspaper, a magazine and a restaurant menu, which are not printed in Braille, can be easily read on the spot.

In another mode of the above handheld Braille converting device, the image capturing means is arranged in and around an area directly-below the Braille converting unit. By this, since the characters in and around the area directly-below the Braille converting unit on which user's fingers are placed are converted to Braille, the user can easily recognize the position of the character(s) being converted to Braille.

In still another mode of the above handheld Braille converting device, the Braille display unit includes multiple single Braille display units each corresponding to one Braille character. Each single Braille display unit includes multiple movable primary members arranged at positions where convex shapes constituting the dots of Braille are formed, and the display control means displays the Braille by lifting up and lowering the primary members to form the convex shapes. By providing multiple single Braille display units in this way, the user can recognize by using their fingers, a small number of Braille characters, in a similar manner to normal Braille. The primary member may be a pin or a ball, which is lifted up to form the convex shape.

In still another mode of the above handheld Braille converting device, the Braille display unit includes multiple movable secondary members not constituting Braille characters, and the display control means displays whether or not relative position the relative position of the handheld Braille converting device is correct with respect to a character or character string existing in the captured image, by operating a part of or all the secondary members. The object used to judge the correctness of the relative position of the handheld Braille converting device may be a character (a representative character at the center of the characters if multiple characters exist) or character string existing in the captured image. If only one character exists in the captured image, that character may be used. If multiple characters exist in the captured image, the character string may be used. In this mode, the user can judge whether the position of the handheld Braille converting device is correct or not with respect to the character or the character string by checking the operation of the secondary members with their finger tips.

In still another mode of the above handheld Braille converting device, the display control means operates a part of the multiple secondary members to indicate in which direction the position of the handheld Braille converting device is shifted with respect to the character or the character string existing in the captured image. In this mode, when the Braille converting device cannot correctly read the characters, the user can know the direction, in which the Braille converting device is shifted with respect to the character or the character string, by checking the operation of the secondary members with their finger tips.

In still another mode of the above handheld Braille converting device, the display control means operates a part of or all the multiple secondary members to indicate the presence/absence of character(s) in the captured image. In this mode, the user can know whether or not the character exists in the captured image by checking the operation of the secondary member with their finger tips. When the Braille is not displayed even though the character exists in the captured image, the user can know that the character cannot be recognized or converted to Braille.

In still another mode of the above handheld Braille converting device, the display control means operates a part of or all the multiple secondary members to indicate whether the character string existing in the captured image is written vertically or horizontally. In this mode, by checking the operation of the secondary members with their finger tips, the user can judge whether the character string existing in the captured image is written vertically or horizontally, thereby allowing them to move the Braille converting device in the correct direction.

In still another mode of the above handheld Braille converting device, the Braille display unit includes a movable third member not constituting Braille characters, and the display control means operates the third member to indicate the presence/absence of character(s) in the captured image. In this mode, by checking the operation of the third member, the user can know whether or not character(s) exist in the captured image. When Braille is not displayed even though the character exists in the captured image, the user can know that the character(s) cannot be recognized or converted to Braille.

In still another mode of the above handheld Braille converting device, the Braille display unit includes movable fourth members not constituting e Braille characters, and the display control means operates the fourth members to indicate whether the character string existing in the captured image is written vertically or horizontally. In this mode, by checking the operation of the fourth members with their fingertips, the user can judge whether the character string existing in the captured image is written vertically or horizontally, thereby allowing them to move the Braille converting device in the correct direction.

In still another mode of the above handheld Braille converting device, at least one of the secondary member, the third member or the fourth member has a shape, a size or a surface feeling of the member that is different from that of the primary member. By this, the user can distinguish the secondary member, the third member and the fourth member, from the primary members. The secondary member, the third member and the fourth member may be a pin, a ball or a vibration member that the user can recognize by touch with their finger.

In still another mode of the above handheld Braille converting device, the Braille display unit includes multiple single Braille display units each corresponding to one Braille character, and the secondary members, the third members or the fourth members are arranged around the outside of the multiple single Braille display units. Because of this, the user can distinguish the secondary members, the third members and the fourth members, from the single Braille display units.

According to another aspect of the present invention, there is provided a Braille converting method executed by a handheld Braille converting device movable while being held by a user by a single hand and including a Braille display unit which is arranged at a position capable of being contacted by at least one finger of a hand of the user holding the device and which displays Braille, the method comprising: an image capturing process which captures a predetermined range around the device; a character recognition process which detects the presence/absence of character(s) existing in an image captured by the capturing process and recognizes the character(s); a Braille converting process which converts a part of or all the characters recognized by the character recognition process to Braille; and a display control process which displays the Braille converted by the Braille converting process on the Braille display unit.

According to still another aspect of the present invention, there is provided a Braille converting program executed by a handheld Braille converting device movable while being held by a user by a single hand and including a Braille display unit which is arranged at a position capable of being contacted by at least one finger of a hand of the user holding the device and which displays Braille, the program making the Braille converting device function as: an image capturing means which captures a predetermined range around the device; a character recognition means which detects the presence/absence of character(s) existing in an image captured by the image capturing means and recognizes the character(s); a Braille converting means which converts a part of or all the characters recognized by the character recognition means to Braille; and a display control means which displays the Braille converted by the Braille converting means on the Braille display unit.

By the Braille converting method or the Braille converting program described-above, it is possible to provide a Braille converting device having a simple system and a low manufacturing cost, and capable of easily converting a character on a printed matter into Braille on the spot. The Braille converting program may be handled in a suitable manner by being stored on a storage medium.

### Embodiment

A preferred embodiment of the present invention will be described below with reference to the attached drawings.

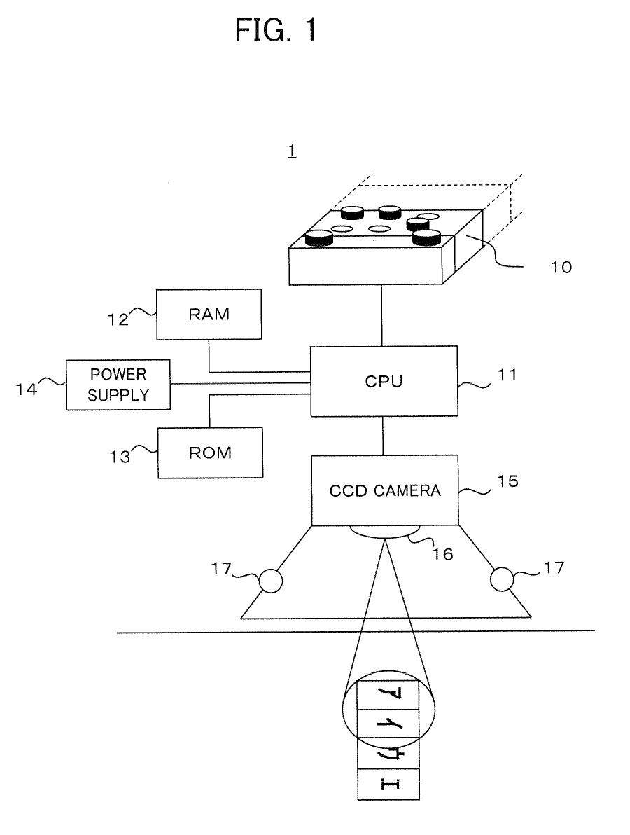

FIG. 1 shows a configuration of a handheld Braille converting device 1 according to an embodiment of the present invention. As shown, the handheld Braille converting device 1 includes a Braille display unit 10, a CPU 11, a RAM 12, a ROM 13, a power supply 14, a CCD camera 15, a lens 16 and a lighting LED 17.

The Braille display unit 10 has multiple movable pins as shown, and displays the Braille by lifting up and lowering the pins to form convex shapes. The detail of the arrangement of the movable pins will be described later.

When a user puts the handheld Braille converting device 1 on a printed matter, the CCD camera 15 captures a predetermined range around the handheld Braille converting device 1, and transmits a captured image to the CPU 11. The CPU 11 detects the presence/absence of character(s) in the captured image obtained from the CCD camera 15, and executes OCR (Optical Character Recognition) processing to recognize the characters if there are characters. The CPU 11 refers to dictionary information associating Chinese characters with their pronunciation and Braille definition information associating each pronunciation with its Braille equivalent, stored in the memory such as the RAM 12 and the ROM 13, and converts the recognized characters to Braille. Then, the CPU 11 displays the converted Braille on the Braille display unit 10. The power supply 14 supplies the power to the handheld Braille converting device 1. The lens 16 is a lens of the CCD camera 15, and the lighting LED 17 is a light source which is necessary for the CCD camera 15 to capture the characters.

FIGS. 2A and 2B show the structure of the handheld Braille converting device 1 according to the embodiment of the present invention. FIG. 2A is a cross-section side-view showing the internal structure of the handheld Braille converting device 1, and FIG. 2B is a bird's-eye view showing the internal structure of the handheld Braille converting device 1 by broken lines. The handheld Braille converting device 1 is a handheld type device which the user can move by holding with a single hand, and includes the Braille display unit 10, the power supply 14, the CCD camera 15, the lens 16, the lighting LED 17 and a system controller 19 in its inside. The CCD camera 15 and the system controller 19 are electrically connected by wiring. The system controller 19 and the Braille display unit 10 are electrically connected by wiring, and the system controller 19 and the power supply 14 are electrically connected by wiring.

The Braille display unit 10 is arranged at the position where at least one of the first to third fingers can contact the Braille display unit 10 when the user holds the handheld Braille converting device 1 by the thumb and the little finger.

The CCD camera 15, the lens 16 and the lighting LED 17 are arranged in and around the area directly-below the Braille display unit 10. In this embodiment, the expression “in and around the area directly-below” includes the area which is just below the Braille display unit and the area within a predetermined distance from this area. The predetermined distance is 3 cm, for example. The system controller 19 includes the CPU 11, the RAM 12 and the ROM 13, and controls the handheld Braille converting device 1 in its entirety. The power supply 14 may be a battery, for example, and supplies the power to the system controller 19 and also to each part of the handheld Braille converting device 1 via the system controller 19.

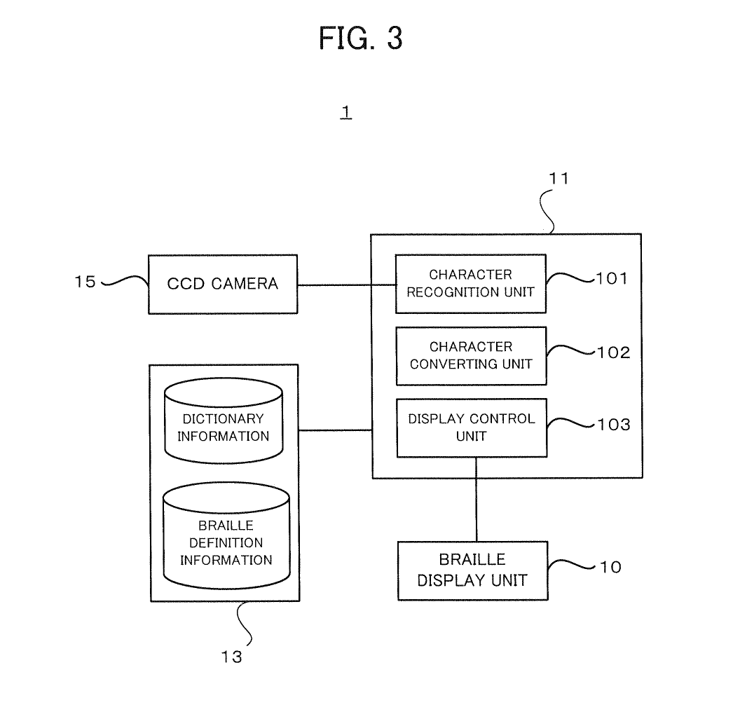

FIG. 3 shows the functional configuration of the handheld Braille converting device 1 of this embodiment. These functions are realized by the constitutional elements shown in FIG. 1.

The handheld Braille converting device 1 includes the CCD camera 15, the CPU 11, the ROM 13 and the Braille display unit 10. The CPU 11 executes the program prepared in advance to function as a character recognition unit 101, a Braille converting unit 102 and a display control unit 103. The ROM 13 stores the dictionary information and the Braille definition information. A part of the dictionary information and the Braille definition information may be stored in the RAM 12.

The CCD camera 15 captures the predetermined range around the handheld Braille converting device 1, and transmits the captured image to the CPU 11. The CCD camera 15 functions as the image capturing means in the present invention.

The character recognition unit 101 detects the presence/absence of the characters in the captured image received from the CCD camera 15, and executes the OCR processing to recognize the characters if there are characters.

When the character recognized by the character recognition unit 101 is Chinese character, the Braille converting unit 102 first converts the Chinese character to the reading based on the dictionary information associating the Chinese character with its pronunciation, and then converts the pronunciation to Braille based on the Braille definition information associating the pronunciation with its Braille equivalent. When the character recognized by the character recognition unit 101 is a hiragana character, a katakana character, a numeral or an alphabet, the Braille converting unit 102 converts them to Braille based on the Braille definition information associating them with their Braille equivalent. The Braille converting unit 102 may convert all the detected characters to Braille, or may convert only a part of the detected characters (e.g., only the number of characters displayable on the Braille display unit 10) to Braille.

The display control unit 103 displays the Braille converted by the Braille converting unit 102 on the Braille display unit 10.

The Braille display unit 10 performs the Braille display and the relative position indication display by lifting up and lowering the movable pins to form the convex shapes.

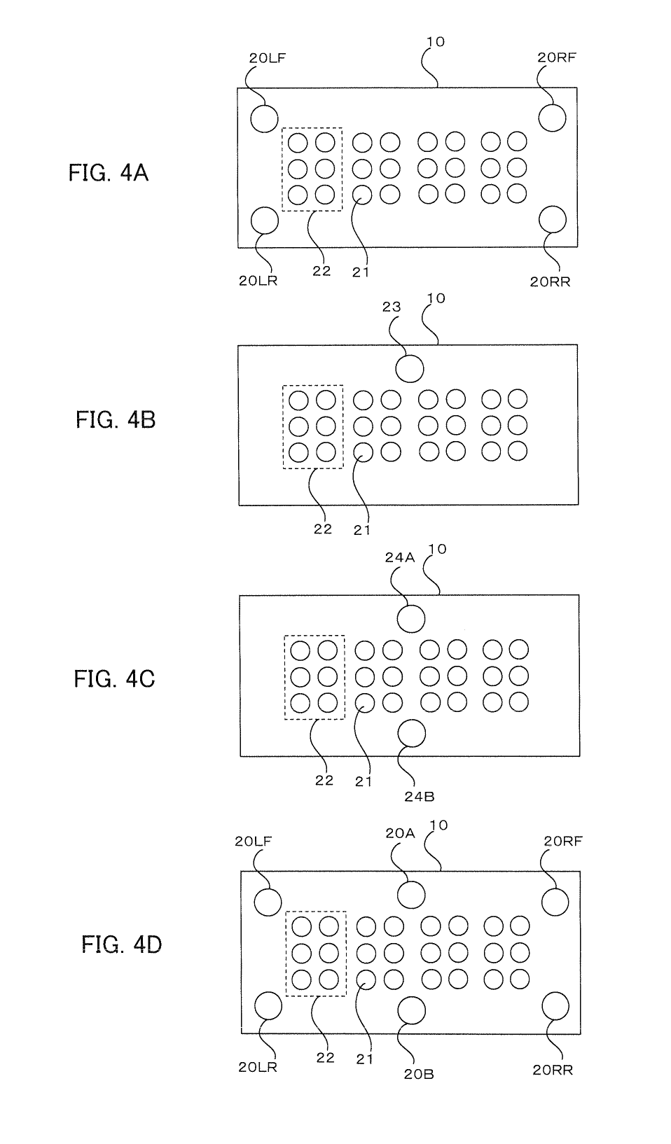

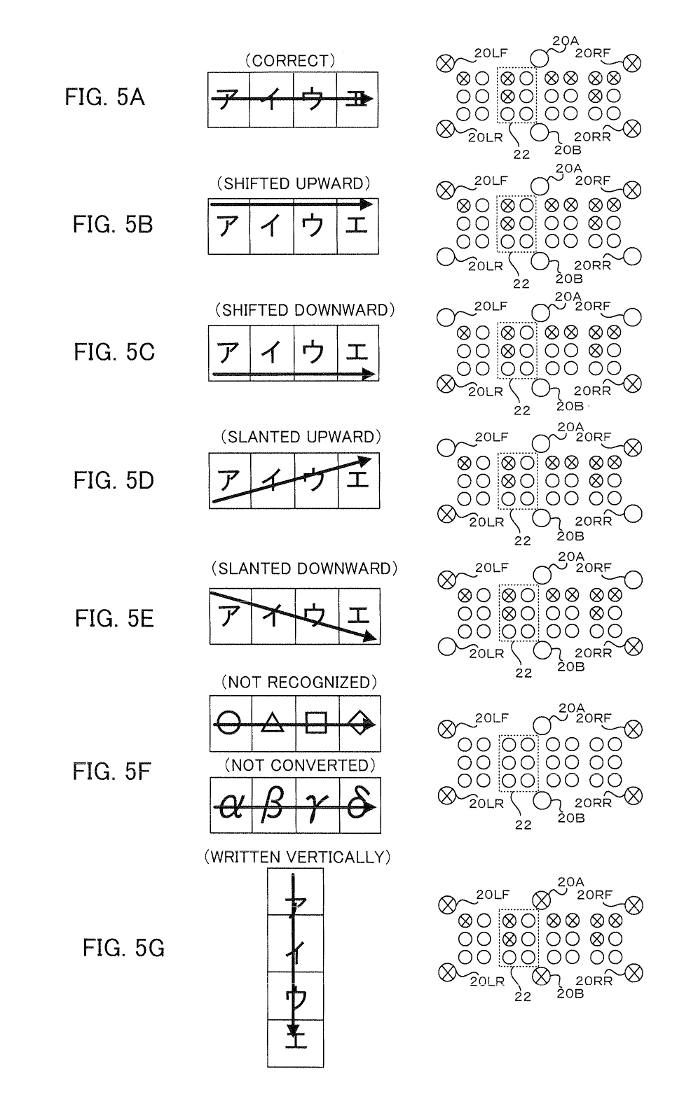

Next, the arrangement of the movable pins of the Braille display unit 10 will be described in detail with reference to FIGS. 4A to 4D and 5A to 5G. FIGS. 4A to 4D are the examples of the Braille display unit 10 according to this embodiment. On the Braille display unit 10, twenty-four movable pins 21 are arranged. Six movable pins 21 constitute one single Braille display unit 22. In total, four single Braille display units 22 are laterally arranged on the Braille display unit 10. One or two single Braille display unit(s) 22 corresponds to one character, and the Braille is displayed by six movable pins 21 lifted up or lowered to form the convex shapes. This movable pin 21 will be hereinafter referred to as “a primary pin”.

In the example of FIG. 4A, the Braille display unit 10 is provided with four movable pins 20LF, 20RF, 20LR and 20RR, outside the four single Braille display units 22. The display control unit 103 makes one or more of the movable pins 20LF, 20RF, 20LR and 20RR project to perform the character presence/absence display and the relative position indication display. These movable pins 20LF, 20RF, 20LR and 20RR will be hereinafter referred to as “secondary pins”.

In the example of FIG. 4B, the Braille display unit 10 is provided with one movable pin 23 outside the four single Braille display units 22. The movable pin 23 displays only the presence/absence of character(s). Specifically, the display control unit 103 lifts up and lowers the movable pin 23 to display whether or not the character recognition unit 101 detects any character in the captured image. This movable pin 23 will be hereinafter referred to as “a third pin”.

In the example of FIG. 4C, the Braille display unit 10 is provided with two movable pins 24A and 24B outside the four single Braille display units 22. The movable pins 24A and 24B display whether the character string existing in the captured image is written vertically or horizontally. Specifically, the display control unit 103 makes the movable pins 24A and 24B project when the character string existing in the captured image is written vertically. These movable pins 24A and 24B will be hereinafter referred to as “fourth pins”.

In the example of FIG. 4D, the Braille display unit 10 is provided with the secondary pins 20LF, 20RF, 20LR and 20RR, as well as the secondary pins 20A and 20B. The display control unit 103 makes the secondary pins 20LF, 20RF, 20LR and 20RR project to perform the character presence/absence display and the relative position indication display, and makes the secondary pins 20A and 20B lift up and lower to display whether the character string existing in the captured image is written vertically or horizontally. Namely, in the example of FIG. 4D, the functions of the third pins and the fourth pins in the examples of FIGS. 4B and 4C are achieved only by the secondary pins.

Next, the description will be given of the examples of the Braille display, the relative position indication display and the display indicating the vertical writing or the horizontal writing. In FIGS. 5A to 5G, the non-protruding pin is represented by a white circle “◯”, and the protruding pin is represented by a “X” within the white circle “◯”. The direction of movement of the handheld Braille converting device 1 is shown by the arrow in FIGS. 5A to 5G.

When the relative position between the handheld Braille converting device 1 and the character or character string existing in the captured image is not correct, the display control unit 103 makes some of the second pins 20LF, 20RF, 20LR and 20RR project, thereby indicating that the character recognition unit 101 detects the existence of character(s) in the captured image and indicating in which direction the position of the handheld Braille converting device 1 is shifted with respect to the character or character string existing in the captured image. When the relative position between the handheld Braille converting device 1 and the character or character string existing in the captured image is correct, the display control unit 103 makes all the second pins 20LF, 20RF, 20LR and 20RR project, thereby indicating that the character recognition unit 101 detects the existence of character(s) in the captured image and indicating that the position of the handheld Braille converting device 1 is correct with respect to the character or character string existing in the captured image. Since the second pins 20LF, 20RF, 20LR and 20RR are larger than the first pin and are arranged outside the single Braille display units 22, the user can discriminate between the primary pins and the secondary pins by the difference of the feeling they present to the fingers.

FIG. 5A is the display example of the case where the position of the handheld Braille converting device 1 is correct with respect to the horizontally written character string existing in the captured image. The handheld Braille converting device 1 is positioned horizontally at the center of the character string existing in the captured image. Thus, when the character recognition unit 101 detects the existence of the characters of the character string [symbol] existing in the captured image and the position of the handheld Braille converting device 1 is correct, the secondary pins 20LF, 20RF, 20LR and 20RR project. Further, when the Braille converting unit 102 can convert the characters to Braille, the four Braille display units 22 display the Braille of the character string [symbol] existing in the captured image. In this example, although the second pins 20LF, 20RF, 20LR and 20RR project when the character recognition unit 101 detects the existence of the characters in the captured image and the position of the handheld Braille converting device 1 is correct, any one of the secondary pins may project instead. Since the character string [symbol] existing in the captured image is written horizontally, the secondary pins 20A and 20B do not project. By this, the user can know that the character string is written horizontally, and that the position of the handheld Braille converting device 1 is correct with respect to the character string.

FIG. 5B is the display example of the case where the position of the handheld Braille converting device 1 is shifted upward with respect to the horizontally written character string existing in the captured image. The handheld Braille converting device 1 is positioned in a manner shifted upward with respect to the character string existing in the captured image. Thus, when the character recognition unit 101 detects the existence of the characters of the character string [symbol] existing in the captured image and the position of the handheld Braille converting device 1 is shifted upward, the secondary pins 20LF and 20RF project. Further, since the character recognition unit 101 recognizes the characters, the four Braille display units 22 display the Braille of the character string [symbol] existing in the captured image. Since the character string [symbol] existing in the captured image is written horizontally, the secondary pins 20A and 20B do not project. In the case of the horizontally written character string, the fact that the secondary pins 20LF and 20RF project indicates that the position of the handheld Braille converting device 1 is shifted upward with respect to the character string existing in the captured image. By this, the user can know that the character string is written horizontally, and that the position of the handheld Braille converting device 1 should be shifted downward.

FIG. 5C is the display example of the case where the position of the handheld Braille converting device 1 is shifted downward with respect to the horizontally written character string existing in the captured image. The handheld Braille converting device 1 is positioned in a manner shifted downward with respect to the character string existing in the captured image. Thus, when the character recognition unit 101 detects the existence of the characters of the character string [symbol] existing in the captured image and the position of the handheld Braille converting device 1 is shifted downward, the secondary pins 20LR and 20RR project. Further, since the character recognition unit 101 recognizes the characters, the four Braille display units 22 display the Braille of the character string [symbol] existing in the captured image. Since the character string [symbol] [symbol] existing in the captured image is written horizontally, the secondary pins 20A and 20B do not project. In the case of the horizontally written character string, the fact that the secondary pins 20LR and 20RR project indicates that the position of the handheld Braille converting device 1 is shifted downward with respect to the character string existing in the captured image. By this, the user can know that the character string is written horizontally, and that the position of the handheld Braille converting device 1 should be shifted upward.

FIG. 5D is the display example of the case where the position of the handheld Braille converting device 1 is slanted upward with respect to the horizontally written character string existing in the captured image. The handheld Braille converting device 1 is positioned in a manner slanted upward (i.e., upward to the right) with respect to the character string existing in the captured image. Thus, when the character recognition unit 101 detects the existence of the characters of the character string [symbol] existing in the captured image and the position of the handheld Braille converting device 1 is slanted upward, the secondary pins 20LR and 20RF project. Further, since the character recognition unit 101 recognizes the characters, the four Braille display units 22 display the Braille of the character string [symbol] [symbol] existing in the captured image. Since the character string [symbol] existing in the captured image is written horizontally, the secondary pins 20A and 20B do not project. In the case of the horizontally written character string, the fact that the second pins 20LR and 20RF project indicates that the position of the handheld Braille converting device 1 is slanted upward with respect to the character string existing in the captured image. By this, the user can know that the character string is written horizontally, and that the position of the handheld Braille converting device 1 should be slanted downward (i.e., downward to the right).

FIG. 5E is the display example of the case where the position of the handheld Braille converting device 1 is slanted downward with respect to the horizontally written character string existing in the captured image. The handheld Braille converting device 1 is positioned in a manner slanted downward (i.e., downward to the right) with respect to the character string existing in the captured image. Thus, when the character recognition unit 101 detects the existence of the characters of the character string [symbol] existing in the captured image and the position of the handheld Braille converting device 1 is slanted downward, the secondary pins 20LF and 20RR project. Further, since the character recognition unit 101 recognizes the characters, the four Braille display units 22 display the Braille of the character string [symbol] existing in the captured image. Since the character string [symbol] existing in the captured image is written horizontally, the secondary pins 20A and 20B do not project. In the case of the horizontally written character string, the fact that the secondary pins 20LF and 20RR project indicates that the position of the handheld Braille converting device 1 is slanted downward with respect to the character string existing in the captured image. By this, the user can know that the character string is written horizontally, and that the position of the handheld Braille converting device 1 should be slanted upward (i.e., upward to the right).

In this embodiment, the fact that at least one of the secondary pins project indicates that the character recognition unit 101 detects the existence of character(s) in the captured image.

In the above-described examples of FIG. 5A to 5E, the relative position between the handheld Braille converting device 1 and the character string existing in the captured image can be determined by the character recognition unit 101 which analyzes the captured image supplied from the CCD camera 15. Specifically, when the character string exists almost at the center in the vertical direction of the captured image from the CCD camera 15, the character recognition unit 101 determines that the handheld Braille converting device 1 is at the correct position with respect to the character string existing in the captured image as shown in FIG. 5A. On the other hand, when the character string exists only on the lower side of the captured image from the CCD camera 15, the character recognition unit 101 determines that the handheld Braille converting device 1 is shifted upward with respect to the character string existing in the captured image as shown in FIG. 5B. Conversely, when the character string exists only on the upper side of the captured image from the CCD camera 15, the character recognition unit 101 determines that the handheld Braille converting device 1 is shifted downward with respect to the character string existing in the captured image as shown in FIG. 5C.

When the position of the character string moves from the upper side to the lower side as the character string progresses in the captured image from the CCD camera 15, the character recognition unit 101 determines that the handheld Braille converting device 1 is slanted upward with respect to the character string existing in the captured image as shown in FIG. 5D. Conversely, when the position of the character string moves from the lower side to the upper side as the character string progresses in the captured image from the CCD camera 15, the character recognition unit 101 determines that the handheld Braille converting device 1 is slanted downward with respect to the character string existing in the captured image as shown in FIG. 5E.

In the examples of FIGS. 5B to 5E, the relative position between the handheld Braille converting device 1 and the character string existing in the captured image is not correct, but the character recognition unit 101 can recognize the characters. Therefore, the Braille is displayed on the Braille display unit 10. When the shift in the relative position between the handheld Braille converting device 1 and the character string existing in the captured image is so large that the character recognition unit 101 cannot recognize the character(s), the Braille is not displayed on the Braille display unit 10, and only the shift direction is displayed.

FIG. 5F is the display example of the case where the character recognition unit 101 can detect the characters existing in the captured image but cannot recognize the characters, or the case that the character recognition unit 101 can recognize the characters but the Braille converting unit 102 cannot convert the characters to Braille. For example, the character recognition unit 101 detects the existence of the characters of the character string ┌◯┘ ┌Δ┘ ┌□┘┌566 ┘ existing in the captured image and the position of the handheld Braille converting device 1 is correct, the secondary pins 20LF, 20RF, 20LR and 20RR project. However, since the characters cannot be recognized, the four single Braille display units 22 do not display anything. In the case where the character recognition unit 101 can recognize Greek characters but the Braille converting unit 102 cannot convert Greek characters, when the character recognition unit 101 detects the existence of the characters of the character string ┌α┘ ┌β┘ ┌γ┘ ┌δ┘ existing in the captured image and the position of the handheld Braille converting device 1 is correct, the secondary pins 20LF, 20RF, 20LR and 20RR project. However, since the characters cannot be converted to Braille, the four single Braille display units 22 do not display anything. By this, the user can know that the characters exist but they cannot be recognized or cannot be converted to Braille.

FIG. 5G is a display example of the case where the character string existing in the captured image is written vertically. The handheld Braille converting device 1 is positioned at the center of the character string existing in the captured image. Since the character recognition unit 101 detects the characters of the vertically written character string [symbol] existing in the captured image and the position of the handheld Braille converting device 1 is correct, the secondary pins 20LF, 20RF, 20LR and 20RR project. Further, when the Braille converting unit 102 can convert the characters to Braille, the four single Braille display units 22 display the character string [symbol] [symbol] existing in the captured image. Since the character string [symbol] existing in the captured image is written vertically, the secondary pins 20A and 20B project. By this, the user can know that the character string is written vertically and that the position of the handheld Braille converting device 1 is correct with respect to the character string.

When the character string is written vertically, the fact that the secondary pins 20RF and 20RR project indicates that the position of the handheld Braille converting device 1 is shifted rightward with respect to the character string existing in the captured image, and the fact that the secondary pins 20LF and 20RF project indicates that the position of the handheld Braille converting device 1 is shifted leftward with respect to the character string existing in the captured image. Further, the fact that the secondary pins 20RF and 20LR project indicates that the position of the handheld Braille converting device 1 is slanted leftward with respect to the character string existing in the captured image, and the fact that the secondary pins 20LF and 20RR project indicates that the position of the handheld Braille converting device 1 is slanted rightward with respect to the character string existing in the captured image.

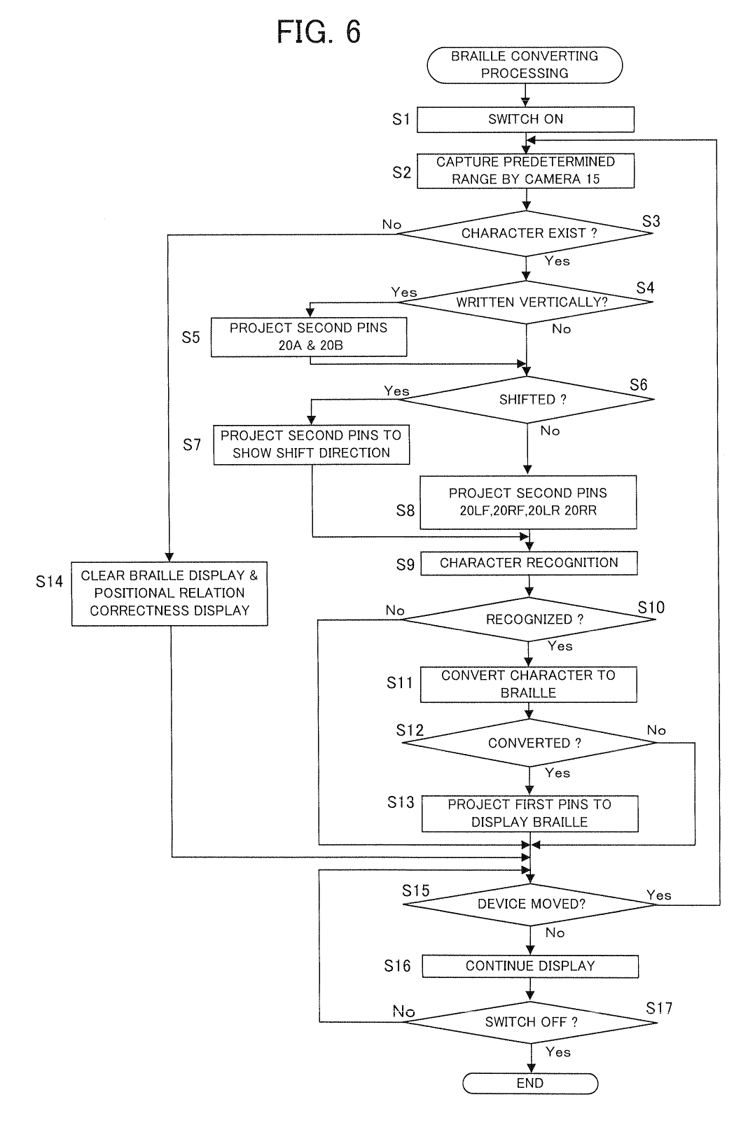

Next, the Braille converting processing according to this embodiment will be described with reference to FIG. 6. This processing is realized by the system controller 19 shown in FIG. 1 which executes the program prepared in advance. FIG. 6 is a flowchart of the Braille converting processing.

The user puts the handheld Braille converting device 1 on the printed matter on which characters to be displayed as Braille exist, and turns on the switch of the Braille converting processing (step S1). The CCD camera 15 captures the predetermined range around the handheld Braille converting device 1 (step S2), and transmits the captured image to the character recognition unit 101. The character recognition unit 101 determines whether not any character(s) exist in the captured image received (step S3). When some characters exists in the captured image (step S3; Yes), the character recognition unit 101 determines whether or not the character string is written vertically (step S4). When character string is written vertically (step S4; Yes), the display control unit 103 makes the secondary pins 20A and 20B project (step S5), and executes step S6. When the character string is not written vertically (step S4; No), the character recognition unit 101 determines whether or not the character string is shifted (step S6). When the character string is shifted (step S6; Yes), the display control unit 103 makes some of the secondary pins 20LF, 20RF, 20LR and 20RR project to indicate the direction of the shift (step S7), and executes step S9. When the character string is not shifted (step S6; No), the display control unit 103 makes the secondary pins 20LF, 20RF, 20LR and 20RR project (step S8).

Next, the character recognition unit 101 recognizes the characters existing in the captured image (step S9). The character recognition unit 101 determines whether or not the characters can be recognized (step S10). When the characters cannot be recognized (step S10; No), the character recognition unit 101 executes step S15. When the characters can be recognized (step S10; Yes), the Braille converting unit 102 converts the characters recognized by the character recognition unit 101 to Braille (step S11). Then, the Braille converting unit 102 determines whether or not the recognized characters can be converted (step S12). When the characters cannot be converted to Braille (step S12; No), step S15 is executed. When the characters can be converted to Braille (step S12; Yes), the display control unit 103 makes the primary pins project to display the converted Braille on the Braille display unit 10 (step S13), and executes step S15.

On the other hand, when no character exists in the captured image (step S3; No), the Braille display and the relative position indication display are all cleared (step S14), and step S15 is executed.

In step S15, the CCD camera 15 determines whether or not the device has moved, based on the change of the captured image. When the device has moved (step S15; Yes), the process goes back to step S2 to repeat steps S2 to S15. When the device has not moved (step S15; No), the display is continued (step S16), and it is determined whether or not the switch is turned off (step S17). When the switch is not turned off (step S17; No), the process goes back to step S15 to repeat steps S15 to S17. When the switch is turned off (step S17; Yes), the process ends.

As described above, the handheld Braille converting device of this embodiment is easy for the user to carry, and can easily convert the characters on the printed matter on the spot.

### Modified Example

Although the Braille display unit includes four single Braille display units in the above-described embodiment, the present invention is not limited to this. The number of character may be determined to be the number that the user can recognize with their fingers most easily.

Although the secondary pins are larger than the primary pins constituting the single Braille display unit and are arranged outside the multiple single Braille display units in the above-described embodiment, the present invention is not limited to this. As a method of distinguishing the primary pins and the secondary pins from each other, the primary pins and the secondary pins may have different texture. Similarly, the primary pins may be distinguished from the third pins and the fourth pins by the shape, the size, the texture of the surface of the pins or their arrangement.

Although the secondary pins, the third pins and the fourth pins are lifted up and lowered at the time of displaying the presence/absence of characters, the correctness of the relative position and whether the character string is written vertically or horizontally in the above-described embodiment, the present invention is not limited to this. Other methods, such as vibrating the secondary pins, the third pins and the fourth pins, may be used to notify them to the user.

Although characters in the printed matter are converted to Braille in the above-described embodiment, the present invention is not limited to this. Other than printed characters, any characters that can be captured by the CCD camera can be converted to Braille.

In the above-described embodiment, the fact that the two secondary pins at the left-lower position and the right-upper position project indicates that the position of the handheld Braille converting device 1 is slanted upward with respect to the character string existing in the captured image, and the fact that two secondary pins at the left-upper position and the right-lower position project indicates that the position of the handheld Braille converting device 1 is slanted downward with respect to the character string in the captured image. However, the present invention is not limited to this, and the above representations can be reversed. Namely, the fact that the two secondary pins at the left-lower position and the right-upper position project may indicate the instruction to correct the angle of the handheld Braille converting device 1 obliquely upward, and the fact that two secondary pins at the left-upper position and the right-lower position project may indicate the instruction to correct the angle of the handheld Braille converting device 1 obliquely downward.

### INDUSTRIAL APPLICABILITY

This invention can be used for various devices that convert characters to Braille.

### BRIEF DESCRIPTION OF REFERENCE NUMBERS

1 Handheld Braille Converting Device
10 Braille display unit
11 CPU
15 CCD Camera
19 System Controller
101 Character Recognition Unit
102 Braille Converting Unit
103 Display Control Unit

1.-15. (canceled)

16. A handheld Braille converting device movable while being held by a user by a single hand, comprising:
a Braille display unit which is arranged at a position capable of being contacted by at least one finger of a hand of the user holding the device and which displays Braille;
an image capturing unit which captures a predetermined range around the device;
a character recognition unit which detects the presence/absence of any character(s) existing in an image captured by the capturing unit and recognizes the character(s);
a Braille converting unit which converts a part of or all the characters recognized by the character recognition unit to Braille; and
a display control unit which displays the Braille converted by the Braille converting unit on the Braille display unit,
wherein the Braille display unit includes multiple movable secondary members not constituting Braille characters, and
wherein the display control unit displays whether or not the relative position of the handheld Braille converting device is correct with respect to a character or a character string existing in the captured image, by operating a part of or all the secondary members.

17. The handheld Braille converting device according to claim 16, wherein the handheld Braille converting device is movable on a surface of a printed matter;
wherein the image capturing unit captures a predetermined range on the surface of the printed matter; and
wherein the character recognition unit detects the presence/absence of any character(s) printed on the surface of the printed matter captured and recognizes the characters.

18. The handheld Braille converting device according to claim 16, wherein the image capturing unit is arranged in and around an area directly-below the Braille converting unit.

19. The handheld Braille converting device according to claim 16, wherein the Braille display unit includes multiple single Braille display units each corresponding to one Braille character,
wherein the single Braille display unit includes multiple movable primary members arranged at positions where their convex shapes constitute the individual dots of Braille characters, and
the display control unit displays the Braille by lifting up and lowering the primary members to form the convex shapes.

20. The handheld Braille converting device according to claim 16, wherein the display control unit operates a part of the multiple secondary members to indicate in which direction the position of the handheld Braille converting device is shifted with respect to the character or the character string existing in the captured image.

21. The handheld Braille converting device according to claim 16, wherein the display control unit operates a part of or all the multiple secondary members to indicate the presence/absence of character(s) in the captured image.

22. The handheld Braille converting device according to claim 16, wherein the display control unit operates a part of or all the multiple secondary members to indicate whether the character string existing in the captured image is written vertically or horizontally.

23. The handheld Braille converting device according to claim 16, herein the Braille display unit includes a movable third member not constituting a Braille character, and
wherein the display control unit operates the third member to indicate the presence/absence of any character(s) in the captured image.

24. The handheld Braille converting device according to claim 16,
wherein the Braille display unit includes movable fourth members not constituting a Braille character, and
wherein the display control unit operates the fourth members to indicate whether the character string existing in the captured image is written vertically or horizontally.

25. The handheld Braille converting device according to claim 16, wherein the secondary member has at least one characteristic of shape, size or texture of a surface of the member that is different from that of the primary members.

26. The handheld Braille converting device according to claim 16,
wherein the Braille display unit includes multiple single Braille display units each corresponding to one Braille character, and
wherein the secondary members are arranged outside of the multiple single Braille display units.

27. A Braille converting method executed by a handheld Braille converting device movable while being held by a user by a single hand and including a Braille display unit which is arranged at a position capable of being contacted by at least one finger of a hand of the user holding the device and which displays Braille, the Braille display unit including plural movable secondary members not constituting Braille characters, the method comprising:
an image capturing process which captures a predetermined range around the device;
a character recognition process which detects the presence/absence of any character(s) existing in an image captured by the image capturing process and recognizes the character(s);
a Braille converting process which converts a part of or all the characters recognized by the character recognition process to Braille; and
a display control process which displays the Braille converted by the Braille converting process on the Braille display unit,
wherein the display control process displays whether or not the relative position of the handheld Braille converting device is correct with respect to a character or a character string existing in the captured image, by operating a part of or all the secondary members.

28. A non-transitory computer-readable medium storing a Braille converting program and executed by a computer in a handheld Braille converting device movable while being held by a user by a single hand and including a Braille display unit which is arranged at a position capable of being contacted by at least one finger of a hand of the user holding the device and which displays Braille, the Braille display unit including multiple movable secondary members not constituting Braille characters, the program making the Braille converting device function as:
an image capturing unit which captures a predetermined range around the device;
a character recognition unit which detects the presence/absence of any character(s) existing in an image captured image by the image capturing unit and recognizes the character(s);
a Braille converting unit which converts a part of or all the characters recognized by the character recognition unit to Braille; and
a display control unit which displays the Braille converted by the Braille converting unit on the Braille display unit, wherein the display control unit displays whether or not the relative position of the handheld Braille converting device is correct with respect to a character or a character string existing in the captured image, by operating a part of or all the secondary members.

29. A storage medium storing the Braille converting program according to claim 28.
